(19) United States
(12) Patent Application Publication
(10) Pub. No.: US 2026/0079736 A1
(43) Pub. Date: Mar. 19, 2026

(54) DATABASE SYSTEMS AND METHODS FOR FLEXIBLE APPLICATION LOCALIZATIONS

(71) Applicant: Salesforce, Inc., San Francisco, CA (US)

(72) Inventors: Angela Liu, Remote, CA (US); Jamie Wutke, Remote (CA); Wolfgang Mathurin, San Francisco, CA (US); Dongyao Ling, San Francisco, CA (US); Heather Sterling, Raleigh, NC (US); Dai Duong Doan, San Francisco, CA (US)

(73) Assignee: Salesforce, Inc., San Francisco, CA (US)

(21) Appl. No.: 18/890,461

(22) Filed: Sep. 19, 2024

(51) Int. Cl. G06F 9/451; G06T 11/60

(52) U.S. Cl. CPC G06F 9/454; G06T 11/60; G06T 2200/24

(57) ABSTRACT

Database systems and methods are provided for dynamic localizations of an application provided at a client device. In response to receiving an indication of a desired localization, an exemplary method retrieves metadata associated with the desired localization for one or more fields of an object associated with an application platform at a database system, retrieves one of more field values for the one or more fields of a data record corresponding to an instance of an object from the database system, and generates a GUI display associated with the application that includes a graphical representation of the data record at the database system utilizing the metadata associated with the desired localization retrieved from the database system and one or more field values for the one or more fields of the data record.

### TECHNICAL FIELD

One or more implementations relate to the field of database systems, and more specifically, to supporting localizations in dynamic applications that interact with records at a database system.

### BACKGROUND

Modern software development has evolved towards web applications or cloud-based applications that provide access to data and services via the Internet or other networks. For example, social media platforms and other collaborative web sites allow users to exchange direct messages or form groups for broadcasting messages and collaborating with one another. In business environments and customer relationship management (CRM) contexts, communication platforms facilitate users sharing information about sales opportunities or other issues surrounding products or services and track changes to projects and sales opportunities by receiving broadcast updates about coworkers, files, and other project related data objects.

In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. Multi-tenant cloud-based architectures have been developed to support multiple user groups (also referred to as “organizations” or “tenants”) using a common hardware and software platform. Some multi-tenant database systems include an application platform that supports a customizable user experience, for example, to create custom applications, web pages, reports, tables, functions, and/or other objects or features.

In practice, it is desirable to provide a cloud-based database system that provides extensibility and flexibility to support applications across different clients using different frameworks. For example, in addition to supporting application customizations within the context of a web browser or other desktop application that allow users to interact with a cloud-based database system to retrieve and access data and other cloud-based services or functionality, it is desirable to provide a similar user experience in the context of a mobile application at a user's cellular phone, tablet or other mobile device. Moreover, in addition to supporting common features and functionality, in some instances, it is desirable to support more customizable user experiences with customizations that can be integrated with an application, adding another layer of complexity between the cloud-based database system and the end user.

In some scenarios, an organization, tenant or other user of a cloud-based database system may desire to enable access to the features and or functionality of their customized application to customers or other users in different geographic locations or in different languages different from the native language in which the customized application was originally developed. Accordingly, it is desirable to allow for dynamically generated customized applications to be adaptable to support different languages or usage in different languages to improve user experiences without requiring hard coding or other changes to the underlying application frameworks.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a computing system according to some example implementations;

FIG. 2 depicts an exemplary graphical user interface (GUI) display suitable for presentation in the computing system of FIG. 1 according to some example implementations;

FIG. 3 is a block diagram illustrating an exemplary web component suitable for use in the computing system of FIG. 1 according to some example implementations;

FIG. 4 is a flow diagram illustrating a dynamic localization process suitable for implementation in the computing system of FIG. 1 according to some example implementations;

FIGS. 5-7 depict exemplary GUI displays associated with an instance of a virtual application suitable for presentation by a client application in the computing system of FIG. 1 in connection with the dynamic localization process of FIG. 4 according to some example implementations;

FIG. 8A is a block diagram illustrating an electronic device according to some example implementations; and

FIG. 8B is a block diagram of a deployment environment according to some example implementations.

### DETAILED DESCRIPTION

The following description describes implementations for enabling client-side data localizations in the context of a database system that supports multiplatform web applications that are customizable or user-configurable or other software as a service (SaaS) environment. As described in greater detail below, the subject matter described herein enables an application to dynamically generate graphical user interface (GUI) displays for web pages, documents, or other files or objects with labels or other static or predefined text in a desired language or other localized format that is different from the default language or localization associated with a particular tenant or user to improve accessibility and enable use of the application across different geographic regions or countries in a manner that is independent of the particular application framework or platform (e.g., web, desktop, mobile, etc.).

For purposes of explanation, the subject matter is described herein primarily in the context of an instance of a virtual application provided by a database system to a client application at a client device over a network to allow a client end user to view one or more GUI displays generated by the instance of the virtual application that graphically depict fields or attributes of data records at the database system corresponding to different objects associated with the virtual application. In response to receiving indication of a desired localization from the user at the client device, the instance of the application provided by the database system to that client device is configurable to override the default language or localization associated with the user to retrieve metadata including labels or other static text in a different language associated with the desired localization for one or more fields of an object at the database system. The retrieved metadata is referenced by and/or passed to the respective components of a GUI display dynamically generated by the instance of the application to provide a graphical representation of the labels or other static text in the desired language while concurrently depicting retrieved field values for the respective fields of a data record corresponding to a particular object or otherwise providing a graphical representation of the data record.

As described in greater detail below, in practice, the localized metadata may be obtained from different sources or otherwise incorporated into components of a GUI display in different manners, which may vary depending on the particular application framework, platform or context in which the GUI display is being generated. Accordingly, in response to receiving indication of a desired localization, one or more services associated with an application platform at the database system are cooperatively configured to retrieve and pass the localized metadata to the components of the GUI display in different manners to ensure that the components of the GUI display are generated with the desired localization. For example, an initial request for the GUI display may include a query parameter appended to the uniform resource locator (URL) associated with the GUI display that indicates the desired localization to override the default localization and bootstrap the instance of the virtual application to retrieve and import metadata with the desired localization rather than referencing cached metadata at the client-side that might otherwise be in a default localization associated with the user. The localization query parameter may be maintained in the URL(s) associated with the instance of the virtual application to allow components of the GUI display to reference the URL to identify the desired localization context before retrieving metadata to be incorporated in those GUI display components. Additionally, the localization query parameter may also be utilized to define or otherwise configure an alternative endpoint that components of the GUI display may call or otherwise reference to identify the desired localization context before retrieving metadata to be incorporated in those GUI display components. The localization query parameter may also be utilized by the instance of the virtual application to automatically download or prime the cache at the client device with metadata in the desired localization or language for subsequent retrieval by GUI display components that refer to client-side cache for dynamic generation.

By virtue of combining the URL application bootstrapping with priming the cache and configuring other endpoints with the desired localization information, GUI display components may be dynamically generated with the desired localization in a manner that is independent of the particular application platform or application framework while also supporting customization or user-configuration of the respective GUI display components and the manner in which they retrieve the localized metadata. In this regard, the GUI display components and respective endpoints utilized to retrieve the respective metadata are capable of functioning in the absence of the localization query parameter (e.g., by defaulting to the user's default localization), while allowing the GUI display components to be customized and designed to load metadata from multiple and/or different endpoints or sources.

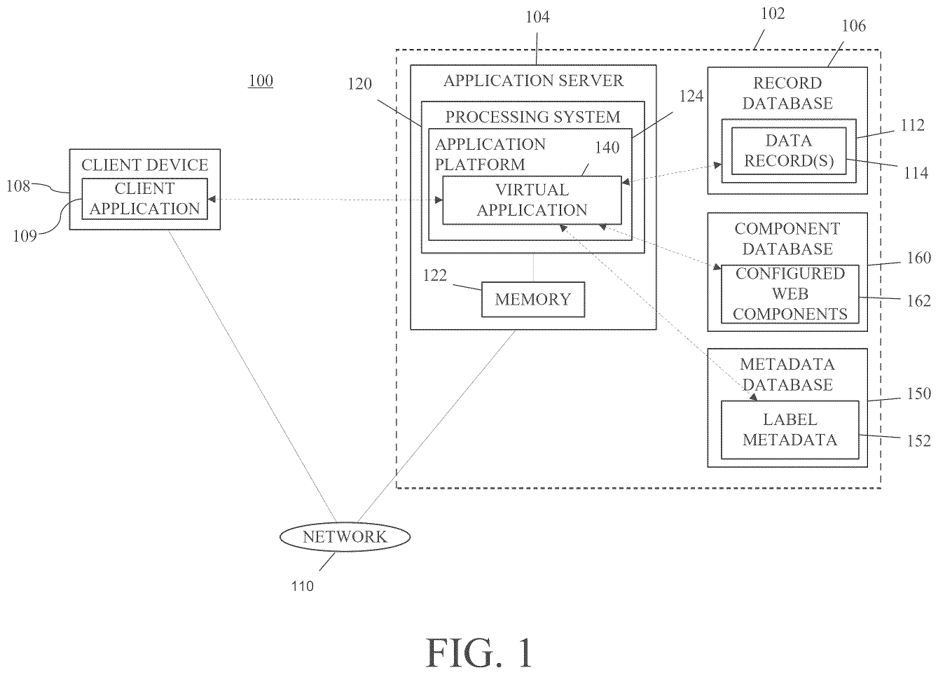

FIG. 1 depicts an exemplary computing system 100 including a database system 102 configurable to provide an application platform 124 capable of concurrently providing instances of one or more virtual applications 140 to client applications 109 at client devices 108 associated with one or more different end users over a communications network 110 (e.g., the Internet or any sort or combination of wired and/or wireless computer network, a cellular network, a mobile broadband network, a radio network, or the like). That said, it should be appreciated that FIG. 1 is a simplified representation of a computing system 100 and is not intended to be limiting. In this regard, it should be noted that although FIG. 1 depicts a database system 102 including multiple different and distinct databases 106, 150, 160, in practice, one or more of the databases 106, 150, 160 may be integrated or otherwise implemented at a common database.

In one or more exemplary implementations, the database system 102 includes one or more application servers 104 that support an application platform 124 capable of providing instances of virtual applications 140, over the network 110, to any number of client devices 108 that users may interact with to view, access or obtain data or other information from one or more data records 114 maintained in one or more data tables 112 at a record database 106 or other repository associated with the database system 102. For example, a record database 106 may maintain, on behalf of a user, tenant, organization or other resource owner, data records 114 entered or created by that resource owner (or users associated therewith), files, objects or other records uploaded by the resource owner (or users associated therewith), and/or files, objects or other records automatically generated by one or more computing processes (e.g., by the server 104 based on user input or other records or files stored in the record database 106). In this regard, in one or more implementations, the database system 102 is realized as an on-demand multi-tenant database system that is capable of dynamically creating and supporting virtual applications 140 based upon data from a common database 106 that is shared between multiple tenants, which may alternatively be referred to herein as a multi-tenant database. Data and services generated by the virtual applications 140 may be provided via the network 110 to any number of client devices 108, as desired, where instances of the virtual application 140 may be suitably generated at run-time (or on-demand) using a common application platform 124 that securely provides access to the data in the record database 106 for each of the various tenants subscribing to the multi-tenant system.

The application server 104 generally represents the one or more server computing devices, server computing systems or other combination of processing logic, circuitry, hardware, and/or other components configured to support remote access to data records 114 maintained in the data tables 112 at the record database 106 via the network 110. Although not illustrated in FIG. 1, in practice, the database system 102 may include any number of application servers 104 in concert with a load balancer that manages the distribution of network traffic across different servers 104 of the database system 102.

In exemplary implementations, the application server 104 generally includes at least one processing system 120, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. Additionally, although not illustrated in FIG. 1, in practice, the application server 104 may also include one or more communications interfaces, which include any number of transmitters, receivers, transceivers, wired network interface controllers (e.g., an Ethernet adapter), wireless adapters or other suitable network interfaces that support communications to/from the network 110 coupled thereto. The application server 104 also includes or otherwise accesses a data storage element 122 (or memory), which may be realized as a local disk, hard disk, random access memory (RAM), read only memory (ROM), flash memory, magnetic or optical mass storage, or any other suitable non-transitory short or long term data storage or other computer-readable media, and/or any suitable combination thereof. In exemplary implementations, the memory 122 stores code or other computer-executable programming instructions that, when executed by the processing system 120, are configurable to cause the processing system 120 to support or otherwise facilitate the application platform 124 and related software services that are configurable to support the subject matter described herein.

The client device 108 generally represents an electronic device coupled to the network 110 that may be utilized by a user to access an instance of the virtual application 140 using an application 109 executing on or at the client device 108. In practice, the client device 108 can be realized as any sort of personal computer, mobile telephone, tablet or other network-enabled electronic device coupled to the network 110 that executes or otherwise supports a web browser or other client application 109 that allows a user to access one or more GUI displays provided by the virtual application 140. In exemplary implementations, the client device 108 includes a display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device 108. Some implementations may support text-to-speech, speech-to-text, or other speech recognition systems, in which case the client device 108 may include a microphone or other audio input device that functions as the user input device, with a speaker or other audio output device capable of functioning as an output device. The illustrated client device 108 executes or otherwise supports a client application 109 that communicates with the application platform 124 provided by the processing system 120 at the application server 104 to access an instance of the virtual application 140 using a networking protocol. In some implementations, the client application 109 is realized as a web browser or similar local client application executed by the client device 108 that contacts the application platform 124 at the application server 104 using a networking protocol, such as hypertext transport protocol secure (HTTPS). In this manner, the client application 109 may be utilized to access or otherwise initiate an instance of a virtual application 140 hosted by the database system 102, where the virtual application 140 provides one or more web page GUI displays within the client application 109 that include GUI elements for interfacing and/or interacting with records 114 maintained at the record database 106.

In exemplary implementations, the record database 106 stores or otherwise maintains data for integration with or invocation by a virtual application 140 in objects organized in object tables 112. In this regard, the record database 106 may include any number of different object tables 112 configured to store or otherwise maintain alphanumeric values or other descriptive information that define a particular instance of a respective type of object associated with a respective object table 112. For example, the virtual application may support a number of different types of objects that may be incorporated into or otherwise depicted or manipulated by the virtual application, with each different type of object having a corresponding object table 112 that includes columns or fields corresponding to the different parameters or criteria that define a particular instance of that object. In some implementations, the record database 106 stores or otherwise maintains application objects (e.g., an application object type) where the application object table 112 includes columns or fields corresponding to the different parameters or criteria that define a particular virtual application 140 capable of being generated or otherwise provided by the application platform 124 on a client device 108. In this regard, the record database 106 may also store or maintain graphical user interface (GUI) objects that may be associated with or referenced by a particular application object and include columns or fields that define the layout, sequencing, and other characteristics of GUI displays to be presented by the application platform 124 on a client device 108 in conjunction with that application 140.

In exemplary implementations, the record database 106 stores or otherwise maintains additional database objects for association and/or integration with a virtual application 140, which may include custom objects and/or standard objects. For example, an administrator user associated with a particular resource owner may utilize an instance of a virtual application 140 to create or otherwise define a new custom field to be added to or associated with a standard object, or define a new custom object type that includes one or more new custom fields associated therewith. In some implementations, the record database 106 may also maintain metadata that defines or describes the fields, process flows, workflows, formulas, business logic, validation rules, structure and other database components or constructs that may be associated with a particular database object.

In the illustrated implementation, the database system 102 also includes a metadata database 150 that stores or otherwise maintains metadata that defines or describes the fields, process flows, formulas, business logic, structure and other database components or constructs that may be associated with various database objects, virtual applications 140 and/or the application platform 124. For purposes of supporting dynamic application localizations described herein, the metadata database 150 stores or otherwise maintains label metadata 152 that includes textual labels or other static text associated with the respective fields or other attributes of the different standard and/or custom database objects maintained in the record database 106 in different languages or other localized formats.

In one or more exemplary implementations, the application platform 124 is configurable to facilitate or generate an instance of a virtual application 140 at run-time or on-demand using configured web components 162 associated with the web application that are maintained in a component database 160 coupled to the application server 104. As described in greater detail below, the configured web components 162 are created, defined, or otherwise configured by a developer, creator, administrator or other user associated with a particular tenant who inputs, selects, configures or otherwise defines values for fields or parameters for instances of web component templates that have been added or selected for integration with a particular web page GUI display associated with the virtual application 140 for that particular tenant's configuration. For example, a developer of a web application may configure, define or otherwise provide other information for one or more fields of a particular database object type for an instance of a web component template added to a web page GUI display of the virtual application, which, in turn, may be utilized by the application platform 124 and/or a client application 109 to retrieve data from the record database 106 and/or the metadata database 150 for incorporation within the virtual application 140 by populating or otherwise generating the instance of the configured web component 162 using the retrieved data at run-time or on-demand.

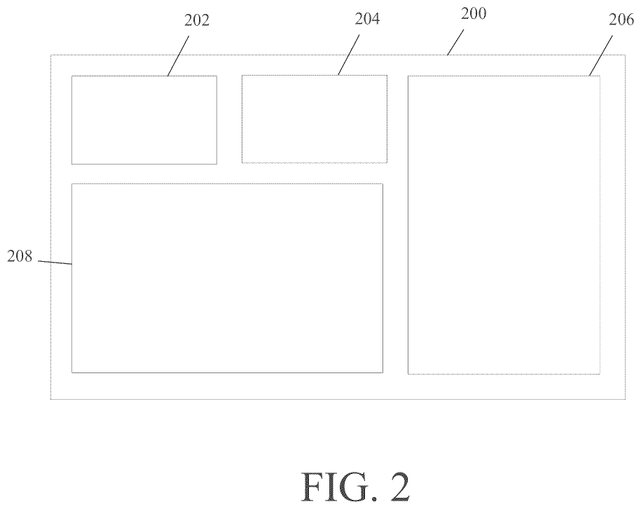

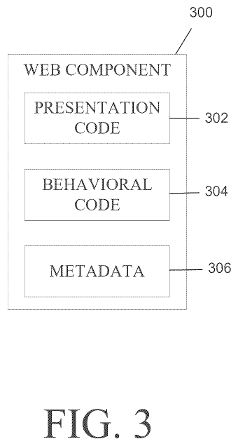

For example, referring to FIGS. 2-3 with continued reference to FIG. 1, in one or more implementations, the processing system 120 executes programming instructions that are configurable cause the application platform 124 to create, generate, or otherwise facilitate a page generation service capable of generating one or more web page GUI displays corresponding to a virtual application 140 created or otherwise developed by a user based on the configured web components 162 associated with the particular instance of the virtual application 140, for example, by retrieving and rendering the configured web components 162 at run-time in accordance with the user-defined configuration.

FIG. 2 depicts an exemplary web page GUI display 200 that includes GUI display components 202, 204, 206, 208 that are dynamically generated at run-time using corresponding web components 162 added to the layout of the web page GUI display 200. For example, a developer user may utilize the page builder feature of the application platform 124 to add instances of web component templates to a web page and define values for the fields associated with the respective web component templates. In this regard, the configurable web component templates generally represent self-contained and reusable elements or other resources that may be added or otherwise incorporated into a web page GUI display and generated or otherwise rendered at run-time in accordance with user-defined or user-configured values for various metadata fields or parameters of the respective web component template. For example, the configurable web component templates may correspond to configurable web components for various GUI elements, such as buttons, text boxes, lists, menus, and/or the like, which may be added to a web page GUI display in a drag and drop manner and then manually configured by a developer user. The page builder feature of the application platform 124 may be configurable to generate and store configured instances of the web component templates in the component database 160 as configured web components 162 associated with that user or tenant's instance of the virtual application 140 that maintains the user-defined values for the respective instances of the web component templates in association with the other code and/or data defining the layout, rendering, or behavior of the respective web component templates added to the respective web page GUI display.

FIG. 3 depicts an exemplary configured web component 300 suitable for use as the configured web components 162 in the computing system of FIG. 1 to generate the respective GUI display components 202, 204, 206, 208 of a web page GUI display 200 associated with an instance of a virtual application 140. Exemplary implementations of the configured web components 162, 300 include presentation code 302 (e.g., Hypertext Markup Language (HTML), cascading style sheet (CSS), and/or the like) defining the manner in which the configured web component 162, 300 is to be displayed, rendered or otherwise presented by the client application 109. The configured web component 162, 300 may also include behavioral code 304 (e.g., JavaScript or other client-side executable code) defining the event-driven behavior of the configured web component 162, 300 within the client application 109 (e.g., in response to user actions, server actions, an event associated with another web component, etc.). The configured web component 162, 300 also includes the user-defined metadata 306 for the configured web component 162, 300 which may be invoked, referenced, or otherwise utilized by the presentation code 302 and/or behavioral code 304 to generate and render the configured web component 162, 300. Accordingly, the configured web components 162, 300 may be dynamic, with the content and/or behavior thereof varying each time a web page GUI display including one or more configured web component(s) 162, 300 is viewed or accessed.

In some implementations, the web page GUI display 200 may be implemented or otherwise realized as an aggregate web component 162, 300 that includes HTML code or other presentation code 302 that defines the layout, graphical structure, spatial arrangement or other visual characteristics of the constituent web components 202, 204, 206, 208 contained therein along with JavaScript code or other client-side executable behavioral code 304 that defines the event-driven behavior associated with the web page GUI display 200 and constituent component metadata 306 identifying the respective configured constituent web components 162 to be invoked and rendered within the web page GUI display 200 in accordance with the user-defined positioning and spatial arrangement of the constituent web components 202, 204, 206, 208. In such implementations, when rendering a web page GUI display 200 based on a URL or web page file of a virtual application 140, the client application 109 retrieves and executes the presentation code to generate the GUI display components 202, 204, 206, 208 within the web page GUI display 200 associated with the virtual application 140 by utilizing the constituent component metadata to retrieve and dynamically render the configured constituent web components 162 to populate the respective regions of the web page GUI display 200. Additional implementation details not germane to this disclosure are described in U.S. Pat. No. 11,321,422.

Referring to FIGS. 1-3, in one or more exemplary implementations, to support dynamic localizations within the context of an instance of a virtual application 140, the application platform 124 implements or otherwise supports a dynamic localization service configurable to retrieve label metadata 152 from the metadata database 150 associated with the desired localization and facilitate storing or otherwise maintaining the localized label metadata 152 at a corresponding location where the user-defined metadata 306 for a configured web component 162, 300 may invoke, reference or otherwise incorporate the localized label metadata 152 when generating the respective GUI display component. Additionally, as described in greater detail below, the dynamic localization service may create, define, update or otherwise configure one or more endpoints in accordance with the desired localization, such that the user-defined metadata 306 for a configured web component 162, 300 may cause the presentation code 302 and/or behavioral code 304 for the respective web component 162, 300 to invoke, reference or otherwise call the respective endpoint to facilitate generating the respective GUI display component using the localized label metadata 152 corresponding to the desired localization.

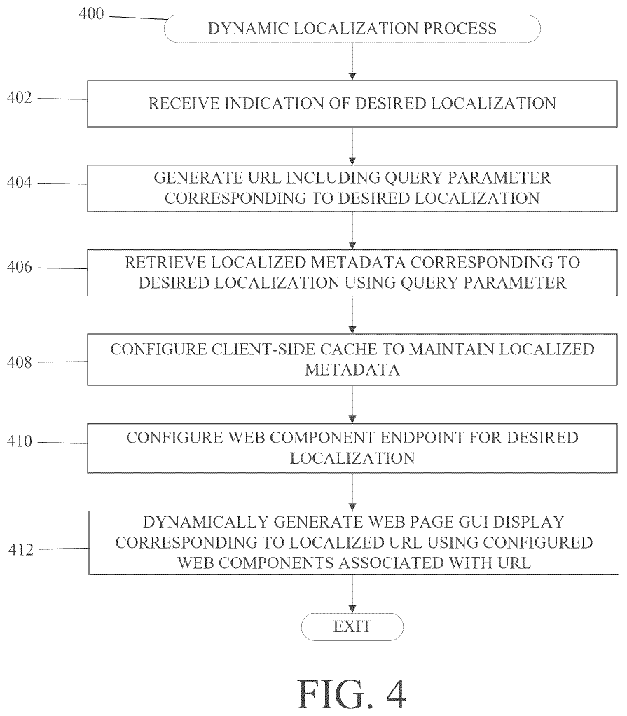

FIG. 4 depicts an exemplary dynamic localization process 400 suitable for implementation by a dynamic localization service associated with an application platform to support dynamic localizations of an instance of a virtual application generated at run-time based on data obtained from a database system and perform additional tasks, functions, and/or operations described herein. For illustrative purposes, the following description may refer to elements mentioned above in connection with FIGS. 1-3. It should be appreciated that the dynamic localization process 400 may include any number of additional or alternative tasks, the tasks need not be performed in the illustrated order and/or the tasks may be performed concurrently, and/or the dynamic localization process 400 may be incorporated into a more comprehensive procedure or process having additional functionality not described in detail herein. Moreover, one or more of the tasks shown and described in the context of FIG. 4 could be omitted from a practical implementation of the dynamic localization process 400 as long as the intended overall functionality remains intact.

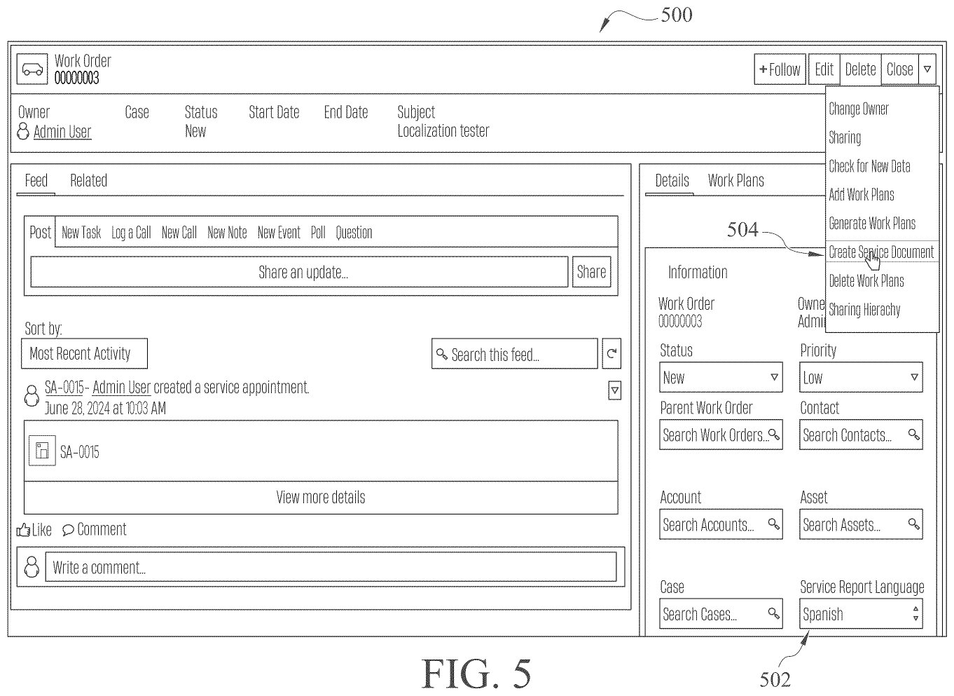

Referring to FIG. 4 with continued reference to FIGS. 1-3, in exemplary implementations, the dynamic localization process 400 initializes or begins in response to receiving indication of a desired localization for an application from a user via a GUI element of a GUI display associated with the application at a client device (task 402). For example, a user at a client device 108 may manipulate or otherwise interact with a GUI element (e.g., a picklist, a drop-down menu, or the like) presented within a GUI display of the virtual application 140 by the client application 109 to select, input or otherwise provide indication of a desired language to be utilized by the virtual application 140 when rendering a particular GUI display of the virtual application 140. For example, FIG. 5 depicts a work order GUI display 500 that may be generated by an instance of a field service virtual application 140 within a client application 109 that includes graphical representations of one or more fields of a particular data record 114 corresponding to an instance of a work order database object that includes a GUI element 502 that is manipulable to identify a different language (e.g., Spanish) that the user would like the instance of the field service virtual application 140 to utilize to generate a service report document GUI display.

Referring again to FIG. 4, the dynamic localization process 400 continues by dynamically generating a URL address for a requested web page GUI display to be generated by the virtual application that includes a query parameter corresponding to the desired localization and retrieving or otherwise obtaining localized metadata corresponding to the desired localization using the query parameter (tasks 404, 406). For example, referring again to FIG. 5, after selecting the desired localization language via the GUI element 502, a user may manipulate another GUI element 504 of the work order GUI display 500 to cause the client application 109 to input or otherwise provide indication of the desired language indicated by the GUI element 502 to the dynamic localization service at the application platform 124 by appending a query parameter indicating the desired localization language to the URL for a service report GUI display to be generated by the virtual application 140. In one implementation, an internationalization and localization URL query parameter (e.g., “_110n”) is utilized to append the desired language to the URL address for the service report GUI display (e.g., by appending “&_110n=sp” to the service report GUI display URL address). Thereafter, the client application 109 may transmit or otherwise provide a corresponding request for the service report GUI display URL address to the application platform 124 at the database system 102 that includes the appended localization query parameter, where the dynamic localization service at the application platform 124 is configured to utilize the appended localization query parameter to override a default language or other default localization parameter associated with the user when retrieving data from one or more databases 106, 150, 160 when generating the service report GUI display corresponding to the URL address. For example, based on the localization URL query parameter, the dynamic localization service at the application platform 124 may query the metadata database 150 to obtain the label metadata 152 including the Spanish language text labels for the fields of the work order data record 114 to be depicted within the service report GUI display.

The dynamic localization process 400 continues by automatically configuring the client-side cache to maintain localized metadata for the desired localization (task 408). For example, the dynamic localization service at the application platform 124 may generate an updated URL address for a GUI display of the virtual application 140 that includes the localization query parameter appended to the URL address that is provided to the client application 109 in connection with the application platform 124 responding to the initial URL request received from the client application 109. For example, the application platform 124 may query the record database 106 to retrieve the values for the particular fields of the work order data record 114 to be depicted by the instance of the virtual application 140 along with the field label metadata associated with those fields of the work order data record 114 from the record database 106 and then transmit or otherwise provide the respective values for those fields of the work order data record 114 and the corresponding field label text for those fields to the client application 109 with an updated URL address that includes the appended localization URL query parameter (“&_110n=sp”). In various implementations, the client application 109 utilizes the appended localization URL query parameter to automatically query and download, from the database system 102 to a cache at the client device 108, label metadata 152 from the label metadata database 150 in the desired language.

In exemplary implementations, the dynamic localization process 400 also automatically configures one or more web component endpoints for the desired localization (task 410). For example, when the requested URL corresponds to a web page GUI display that includes one or more web components 162, the dynamic localization service at the application platform 124 may retrieve those web components 162 and create or otherwise define one or more endpoints for the metadata 306 of those configured web components 162 to include indicia of the desired localization. The application platform 124 may query the component database 160 to retrieve the configured web components 162 for the requested web page GUI display corresponding to the received URL address and transmits or otherwise provides those configured web components 162 to client application 109 in concert with providing the field values for the work order data record 114 and the corresponding updated URL address that includes the appended localization URL query parameter (“&_110n=sp”).

The dynamic localization process 400 continues by dynamically generating a web page GUI display corresponding to a localized URL using configured web components associated with the respective localized URL (task 412). For example, after downloading or otherwise retrieving the field values from a particular data record 114, the localized label metadata 152 for those fields, and the configured web components 162 from the database system 102, the client application 109 may dynamically generate the requested web page GUI display at the client device 108. In this regard, by virtue of the dynamic localization service at the application platform 124 and the dynamic localization process 400, the client application 109 dynamically generates a web page GUI display 200 corresponding to a requested URL associated with the virtual application 140 including dynamically generated GUI display components 202, 204, 206, 208 corresponding to the configured web components 162 associated with that requested URL using localized label metadata 152.

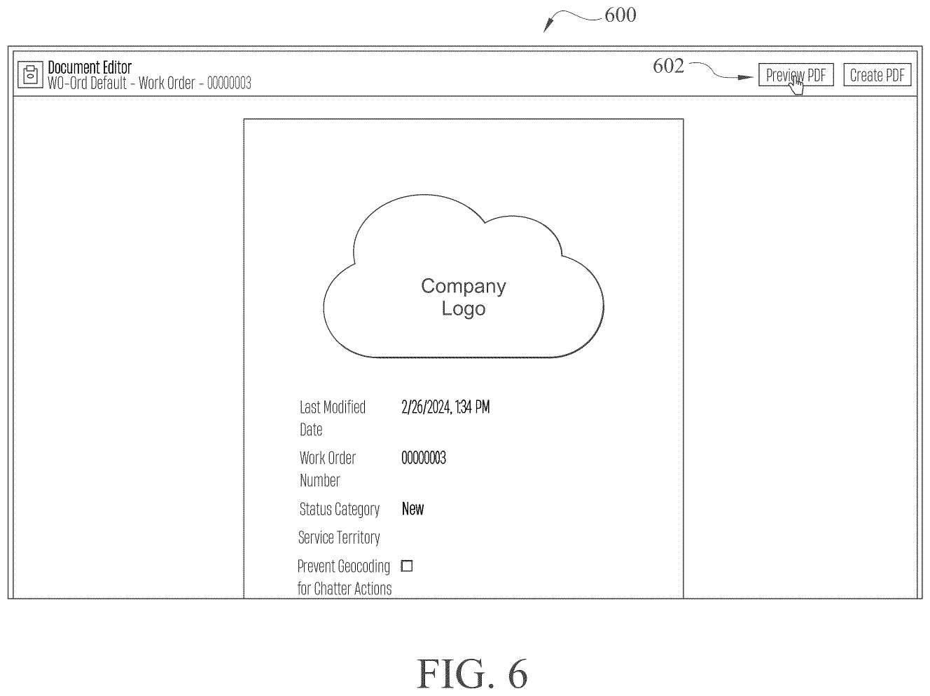

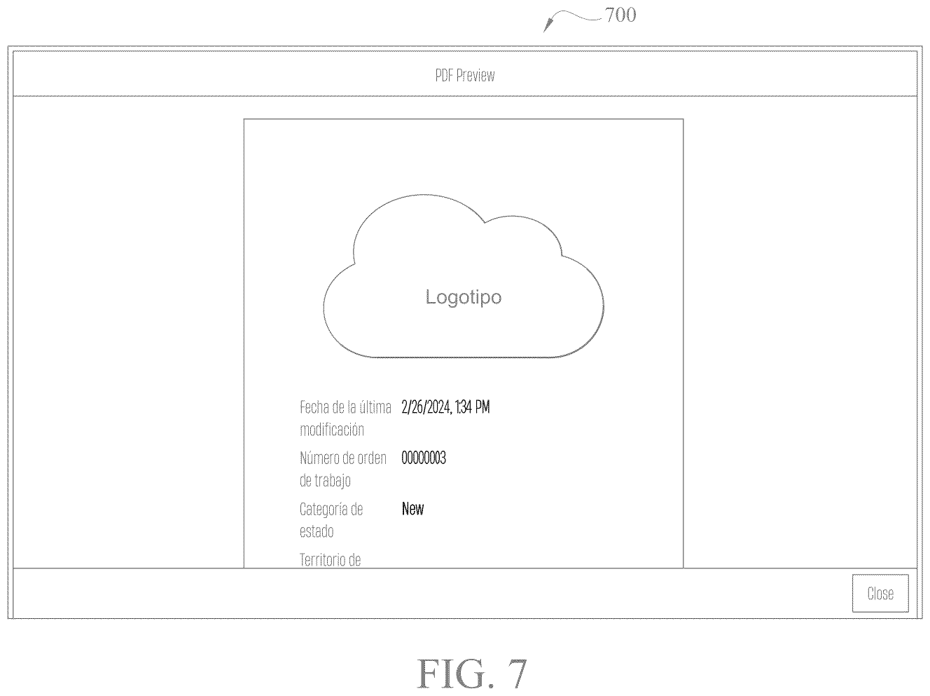

For example, referring to FIGS. 6-7 with continued reference to FIGS. 1-5, in response to selection of the GUI element 504 of the work order GUI display 500, the client application 109 may transmit a request for a localized URL address corresponding to a service document GUI display that causes the dynamic localization service at the application platform 124 to retrieve the field values for the particular work order data record 114 to be depicted on the service document GUI display and corresponding field label text from the record database 106 along with the corresponding web components 162 of the service document GUI display and provide the corresponding data for generating the service document GUI display retrieved from the respective databases 106, 150, 160 to the client application 109 with an updated URL address for the service document GUI display that includes the localization URL query parameter. The client application 109 executes the presentation and behavioral code 302, 304 of the configured web components 162, 300 associate with that URL address to dynamically generate the service document GUI display 600 that includes the retrieved work order data record field values and corresponding field label text in the default language associated with the user. The client application 109 utilizes the localization URL query parameter to download the localized label metadata 152 in the indicated Spanish language from the database system 102 to the local cache at the client device 108 and the client application 109 and/or the application platform 124 automatically updates one or more web component endpoints for a service report GUI display to reflect the desired Spanish language localization. Thereafter, in response to user selection of a GUI element 602 to generate a service report GUI display, the client application 109 may transmit a corresponding localized URL request to the application platform 124, which, in turn, results in the client application 109 generating a service report GUI display 700 having textual field labels in the desired Spanish language depicted in association with the respective field values retrieved from the work order data record 114. In this regard, the configured web components 162 corresponding to the GUI display components of the service report GUI display 700 are dynamically generated in the indicated Spanish language by virtue of the URL address, client-side cache, and other web component endpoints all being updated to reflect the desired localization, such that execution of the respective web components 162 results in the metadata 306 incorporating the Spanish language label metadata 152 by either referencing the local cache or generating a corresponding call or request to an application programming interface (API) or other endpoint at the client device 108 and/or the application platform 124 that reflects the desired localization passed to the web component 162 (e.g., via the localized URL or other endpoint modification).

By virtue of the dynamic localization process 400, a dynamic web page defined using web components can be generated by a web browser, a native mobile application (e.g., field service mobile application) or any other sort of client application 109, independent of the particular application framework or platform relied on by the respective client application 109 for generating the web page GUI display. For example, by appending the localized URL query parameter to an initial request from the client application, the dynamic localization service at the application platform 124 automatically loads, retrieves or otherwise configures global value providers for the instance of the virtual application 140 for the desired localization language on the backend when loading resources to bootstrap the virtual application 140. Thereafter, the localized URL query parameter is passed back to the client application 109 for subsequent or secondary endpoints to cause the client application 109 to perform a language override to cache bust request the desired localization language. Other endpoints are also modified by the dynamic localization service at the application platform 124 to pass the desired localization language and language override to the respective web components 162 (via their configured metadata 306 referencing those endpoints) to additionally cause web components 162 to individually request or retrieve label metadata 152 in the desired language when executed by the client application 109.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read-only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as services) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

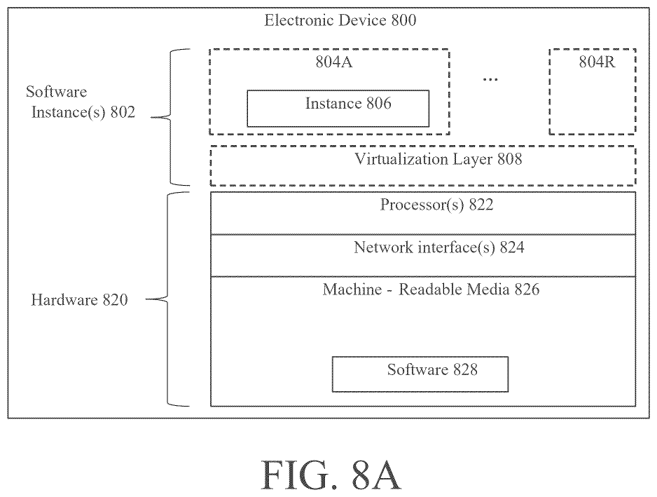

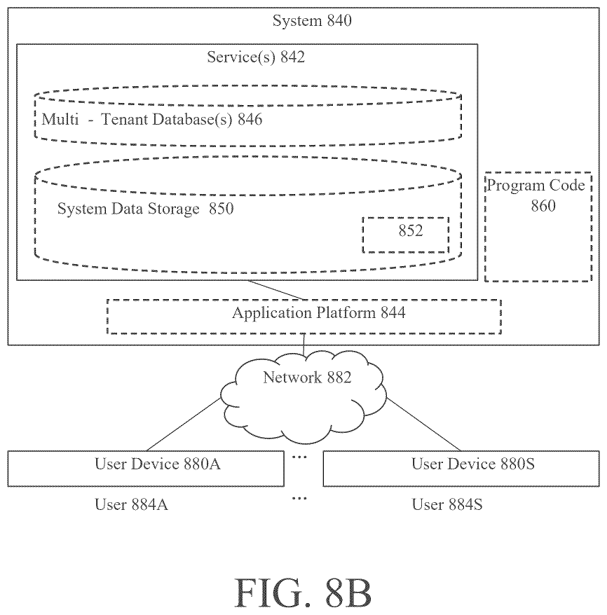

FIG. 8A is a block diagram illustrating an electronic device 800 according to some example implementations. FIG. 8A includes hardware 820 comprising a set of one or more processor(s) 822, a set of one or more network interfaces 824 (wireless and/or wired), and machine-readable media 826 having stored therein software 828 (which includes instructions executable by the set of one or more processor(s) 822). The machine-readable media 826 may include non-transitory and/or transitory machine-readable media. Each of the previously described applications and related services may be implemented in one or more electronic devices 800. In one implementation: 1) each of the clients is implemented in a separate one of the electronic devices 800 (e.g., in end user devices where the software 828 represents the software to implement clients to interface directly and/or indirectly with the dynamic localization service (e.g., software 828 represents a web browser, a native client, a portal, a command-line interface, and/or an application programming interface (API) based upon protocols such as Simple Object Access Protocol (SOAP), Representational State Transfer (REST), etc.)); 2) the dynamic localization service is implemented in a separate set of one or more of the electronic devices 800 (e.g., a set of one or more server devices where the software 828 represents the software to implement the dynamic localization service); and 3) in operation, the electronic devices implementing the clients and the dynamic localization service would be communicatively coupled (e.g., by a network) and would establish between them (or through one or more other layers and/or or other services) connections for submitting requests to the dynamic localization service. Other configurations of electronic devices may be used in other implementations (e.g., an implementation in which the client and the dynamic localization service are implemented on a single one of electronic device 800).

During operation, an instance of the software 828 (illustrated as instance 806 and referred to as a software instance; and in the more specific case of an application, as an application instance) is executed. In electronic devices that use compute virtualization, the set of one or more processor(s) 822 typically execute software to instantiate a virtualization layer 808 and one or more software container(s) 804A-804R (e.g., with operating system-level virtualization, the virtualization layer 808 may represent a container engine (such as Docker Engine by Docker, Inc. or rkt in Container Linux by Red Hat, Inc.) running on top of (or integrated into) an operating system, and it allows for the creation of multiple software containers 804A-804R (representing separate user space instances and also called virtualization engines, virtual private servers, or jails) that may each be used to execute a set of one or more applications; with full virtualization, the virtualization layer 808 represents a hypervisor (sometimes referred to as a virtual machine monitor (VMM)) or a hypervisor executing on top of a host operating system, and the software containers 804A-804R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 828 is executed within the software container 804A on the virtualization layer 808. In electronic devices where compute virtualization is not used, the instance 806 on top of a host operating system is executed on the “bare metal” electronic device 800. The instantiation of the instance 806, as well as the virtualization layer 808 and software containers 804A-804R if implemented, are collectively referred to as software instance(s) 802.

Alternative implementations of an electronic device may have numerous variations from that described above. For example, customized hardware and/or accelerators might also be used in an electronic device.

FIG. 8B is a block diagram of a deployment environment according to some example implementations. A system 840 includes hardware (e.g., a set of one or more server devices) and software to provide service(s) 842, including one or more services configurable to support a dynamic localization service. In some implementations the system 840 is in one or more datacenter(s). These datacenter(s) may be: 1) first party datacenter(s), which are datacenter(s) owned and/or operated by the same entity that provides and/or operates some or all of the software that provides the service(s) 842; and/or 2) third-party datacenter(s), which are datacenter(s) owned and/or operated by one or more different entities than the entity that provides the service(s) 842 (e.g., the different entities may host some or all of the software provided and/or operated by the entity that provides the service(s) 842). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 840 is coupled to user devices 880A-880S over a network 882. The service(s) 842 may be on-demand services that are made available to one or more of the users 884A-884S working for one or more entities other than the entity which owns and/or operates the on-demand services (those users sometimes referred to as outside users) so that those entities need not be concerned with building and/or maintaining a system, but instead may make use of the service(s) 842 when needed (e.g., when needed by the users 884A-884S). The service(s) 842 may communicate with each other and/or with one or more of the user devices 880A-880S via one or more APIs (e.g., a REST API). In some implementations, the user devices 880A-880S are operated by users 884A-884S, and each may be operated as a client device and/or a server device. In some implementations, one or more of the user devices 880A-880S are separate ones of the electronic device 800 or include one or more features of the electronic device 800.

In some implementations, the system 840 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 840 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 840 may include an application platform 844 that enables PAAS for creating, managing, and executing one or more applications developed by the provider of the application platform 844, users accessing the system 840 via one or more of user devices 880A-880S, or third-party application developers accessing the system 840 via one or more of user devices 880A-880S.

In some implementations, one or more of the service(s) 842 may use one or more multi-tenant databases 846, as well as system data storage 850 for system data 852 accessible to system 840. In certain implementations, the system 840 includes a set of one or more servers that are running on server electronic devices and that are configured to handle requests for any authorized user associated with any tenant (there is no server affinity for a user and/or tenant to a specific server). The user devices 880A-880S communicate with the server(s) of system 840 to request and update tenant-level data and system-level data hosted by system 840, and in response the system 840 (e.g., one or more servers in system 840) automatically may generate one or more Structured Query Language (SQL) statements (e.g., one or more SQL queries) that are designed to access the desired information from the multi-tenant database(s) 846 and/or system data storage 850.

In some implementations, the service(s) 842 are implemented using virtual applications dynamically created at run time responsive to queries from the user devices 880A-880S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 862 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 844 includes an application setup mechanism that supports application developers' creation and management of applications, which may be saved as metadata by save routines. Invocations to such applications, including by the dynamic localization service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 882 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 840 and the user devices 880A-880S.

Each user device 880A-880S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 840. For example, the user interface device can be used to access data and applications hosted by system 840, and to perform searches on stored data, and otherwise allow one or more of users 884A-884S to interact with various GUI pages that may be presented to the one or more of users 884A-884S. User devices 880A-880S might communicate with system 840 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 880A-880S might include an HTTP client, commonly referred to as a “browser,” for sending and receiving HTTP messages to and from server(s) of system 840, thus allowing users 884A-884S of the user devices 880A-880S to access, process and view information, pages and applications available to it from system 840 over network 882.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

What is claimed is:

1. A method comprising:
receiving indication of a desired localization for an application from a user via a first graphical user interface (GUI) element of a first GUI display associated with the application at a client device, wherein the desired localization is different from a reference localization associated with the user;
in response to the indication of the desired localization, retrieving, from a database system over a network, metadata associated with the desired localization for one or more fields of an object associated with an application platform at the database system;
retrieving, from the database system, one of more field values for the one or more fields of a data record corresponding to an instance of the object; and
generating, at the client device, a second GUI display associated with the application comprising a graphical representation of the data record at the database system utilizing the metadata associated with the desired localization retrieved from the database system and one or more field values for the one or more fields of the data record.

2. The method of claim 1, wherein the indication comprises a uniform resource locator (URL) query parameter appended to a URL address associated with the second GUI display.

3. The method of claim 2, wherein generating the second GUI display comprises a client application at the client device executing a web component associated with the second GUI display to generate a GUI display component comprising label metadata for a field of the data record and a field value of the one or more field values for the field of the one or more fields of the data record.

4. The method of claim 3, further comprising storing the metadata associated with the desired localization in a cache at the client device, wherein:
the metadata comprises a second label for a second field of the data record in a language different from than a default language associated with the user; and
generating the second GUI display comprises the client application at the client device executing a second web component associated with the second GUI display to generate a second GUI display component comprising the second label for the second field of the data record and a second field value of the one or more field values for the second field of the one or more fields of the data record, wherein configured web component metadata of the second web component is configurable to reference the cache to obtain the second label for the second field of the data record.

5. The method of claim 4, further comprising providing the indication of the desired localization to a third web component associated with the second GUI display, wherein the client application at the client device executes the third web component to retrieve the metadata comprising a third label for a third field of the data record in the language different from than the default language associated with the user from the database system and generate a third GUI display component comprising the third label for the third field of the data record and a third field value of the one or more field values for the third field of the one or more fields of the data record.

6. The method of claim 1, further comprising storing the metadata associated with the desired localization in a cache at the client device, wherein:
the metadata comprises a label for a field of the data record in a different language than a default language associated with the user; and
generating the second GUI display comprises a client application at the client device executing a web component associated with the second GUI display to generate a GUI display component comprising the label for the field of the data record in the different language and a field value of the one or more field values for the field of the one or more fields of the data record, wherein configured web component metadata of the web component is configurable to reference the cache to obtain the label for the field of the data record.

7. The method of claim 1, further comprising providing the indication of the desired localization to a web component associated with the second GUI display, wherein:
retrieving the metadata comprises a client application at the client device executing the web component to retrieve a label for a field of the data record in a different language than a default language associated with the user; and
generating the second GUI display comprises the client application executing presentation code of the web component to generate a GUI display component on the second GUI display comprising the label for the field of the data record in the different language and a field value of the one or more field values for the field of the one or more fields of the data record.

8. At least one non-transitory machine-readable storage medium that provides instructions that, when executed by at least one processor, are configurable to cause the at least one processor to perform operations comprising:
receiving indication of a desired localization for an application from a user via a first graphical user interface (GUI) element of a first GUI display associated with the application at a client device, wherein the desired localization is different from a reference localization associated with the user;
in response to the indication of the desired localization, retrieving, from a database system over a network, metadata associated with the desired localization for one or more fields of an object associated with an application platform at the database system;
retrieving, from the database system, one of more field values for the one or more fields of a data record corresponding to an instance of the object; and
generating, at the client device, a second GUI display associated with the application comprising a graphical representation of the data record at the database system utilizing the metadata associated with the desired localization retrieved from the database system and one or more field values for the one or more fields of the data record.

9. The at least one non-transitory machine-readable storage medium of claim 8, wherein the indication comprises a uniform resource locator (URL) query parameter appended to a URL address associated with the second GUI display.

10. The at least one non-transitory machine-readable storage medium of claim 9, wherein generating the second GUI display comprises a client application at the client device executing a web component associated with the second GUI display to generate a GUI display component comprising label metadata for a field of the data record and a field value of the one or more field values for the field of the one or more fields of the data record.

11. The at least one non-transitory machine-readable storage medium of claim 10, wherein the instructions are configurable to cause the at least one processor to cache the metadata associated with the desired localization at the client device, wherein:
the metadata comprises a second label for a second field of the data record in a language different from than a default language associated with the user; and
generating the second GUI display comprises the client application at the client device executing a second web component associated with the second GUI display to generate a second GUI display component comprising the second label for the second field of the data record and a second field value of the one or more field values for the second field of the one or more fields of the data record, wherein configured web component metadata of the second web component is configurable to reference a cache at the client device to obtain the second label for the second field of the data record.

12. The at least one non-transitory machine-readable storage medium of claim 11, wherein the instructions are configurable to cause the at least one processor to provide the indication of the desired localization to a third web component associated with the second GUI display, wherein the client application at the client device executes the third web component to retrieve the metadata comprising a third label for a third field of the data record in the language different from than the default language associated with the user from the database system and generate a third GUI display component comprising the third label for the third field of the data record and a third field value of the one or more field values for the third field of the one or more fields of the data record.

13. The at least one non-transitory machine-readable storage medium of claim 8, wherein the instructions are configurable to cause the at least one processor to cache the metadata associated with the desired localization in a cache at the client device, wherein:
the metadata comprises a label for a field of the data record in a different language than a default language associated with the user; and
generating the second GUI display comprises a client application at the client device executing a web component associated with the second GUI display to generate a GUI display component comprising the label for the field of the data record in the different language and a field value of the one or more field values for the field of the one or more fields of the data record, wherein configured web component metadata of the web component is configurable to reference the cache to obtain the label for the field of the data record.

14. The at least one non-transitory machine-readable storage medium of claim 8, wherein the instructions are configurable to cause the at least one processor to provide the indication of the desired localization to a web component associated with the second GUI display, wherein:
retrieving the metadata comprises a client application at the client device executing the web component to retrieve a label for a field of the data record in a different language than a default language associated with the user; and
generating the second GUI display comprises the client application executing presentation code of the web component to generate a GUI display component on the second GUI display comprising the label for the field of the data record in the different language and a field value of the one or more field values for the field of the one or more fields of the data record.

15. A computing device comprising:
at least one non-transitory machine-readable storage medium that stores software for a dynamic localization service; and
at least one processor, coupled to the at least one non-transitory machine-readable storage medium, to execute the software that implements the dynamic localization service and that is configurable to:
receive indication of a desired localization for an application from a user via a first graphical user interface (GUI) element of a first GUI display associated with the application at a client device, wherein the desired localization is different from a reference localization associated with the user;
in response to the indication of the desired localization, retrieve, from a database system over a network, metadata associated with the desired localization for one or more fields of an object associated with an application platform at the database system; and
retrieve, from the database system, one of more field values for the one or more fields of a data record corresponding to an instance of the object, wherein a second GUI display associated with the application comprising a graphical representation of the data record at the database system is generated at the client device utilizing the metadata associated with the desired localization retrieved from the database system and one or more field values for the one or more fields of the data record.

16. The computing device of claim 15, wherein the indication comprises a uniform resource locator (URL) query parameter appended to a URL address associated with the second GUI display.

17. The computing device of claim 16, wherein a client application at the client device executes a web component associated with the second GUI display to generate a GUI display component comprising label metadata for a field of the data record and a field value of the one or more field values for the field of the one or more fields of the data record.
